(19) United States
(12) Patent Application Publication
(10) Pub. No.: US 2004/0027246 A1
(43) Pub. Date: Feb. 12, 2004

(54) Portable device with sensors for signalling physiological data

(75) Inventor: Jorge Miguel Aguglia, Lecce (IT)

Correspondence Address: GREER, BURNS & CRAIN, LTD., 25th Floor, 300 S. Wacker Drive, Chicago, IL, 60606, US

(73) Assignee: S.I.E.M. S.R.L.

(21) Appl. No.: 10/216,326

(22) Filed: Aug. 9, 2002

(51) Int. Cl. G08B 23/00

(52) U.S. Cl. 340/573.1; 600/300; 340/539.12

(57) ABSTRACT

A portable device with sensors for signalling physiological data of a human or animal user is disclosed. The device comprises an annular supporting structure such as a bracelet or a collar, having sensing means for monitoring the state of various physiological data, and a common processing unit for comparing reference data memorized therein with the sensed physiological data. The processing unit warns about health hazards on the basis of the comparison and preferably provides a treatment.

### BACKGROUND OF THE INVENTION

The present invention relates to a portable device with sensors for signalling physiological data of a human or animal user, and particularly warning about health hazards and/or providing a treatment.

A person who is not under close medical observation may have the need to constantly monitor his health, especially if he belongs to so-called to-be-protected persons (elderly people, children, invalids).

However, it is not necessary to be affected by a particular health problem: even someone working in a field at risk of accidents or someone who finds himself accidentally in a dangerous condition or has the responsibility for the safety of many people, such as for example a bus or truck driver, may need a device for monitoring and reporting particular data.

Many devices dedicated to the monitoring and general control and protection of health are currently known: for example, there are hospital devices that automatically monitor blood pressure or the heart rate, and there are devices capable of transmitting data over the GSM network.

In particular, the Smart Shirt product by Sensatex consists of a shirt on which there are multiple sensors capable of gathering data from a plurality of regions of the body of the wearer of the shirt; these sensors are capable of measuring heart rate, respiration rate, body temperature and other values that can be detected by sensors in contact with the human body, commonly used in the field of medicine. All the measured data are collected in a device that has the size of an ordinary pager and are sent by a transceiver to a wireless gateway, which determines the appropriate transmission method. The gateway then sends the data over the Internet to a data server, where the information is processed and sent, again over the Internet, to appropriate individuals, such as the wearer of the shirt and/or the persons caring for the health of the wearer.

Processing the information measured by the sensors therefore occurs in an external electronic unit and the device merely sends the data, possibly receiving a return signal that gives an invitation to act as a consequence of the information contained in said data.

Therefore, the user is not warned promptly of any state of danger, so that in certain situations a delay, even a minimal one, regarding the reporting of the danger can be harmful if not even fatal.

Moreover, simple health monitoring necessarily entails an Internet or telephone connection, which is expensive and unnecessary if the measured data remain mostly at normal levels.

### SUMMARY OF THE INVENTION

The aim of the present invention is to provide a wireless signalling device that allows to monitor constantly various physiological data and to analyze them so as to report automatically and promptly any dangers to the user's health.

Within this aim, an object of the invention is to provide the device for a wide range of applications, using always the same basic elements.

Another object is to make the device interact with an actuator that is capable of acting immediately after a danger is reported.

Another object is to reduce the dimensions of said device, devising a shape and dimensions that are compatible with the physical areas to be monitored.

This aim and these and other objects which will become better apparent hereinafter are achieved by the portable device with sensors for signalling physiological data according to the invention, comprising:

a supporting structure that can be worn by a human or animal user;

sensing means mounted on said supporting structure in order to acquire physiological data of said user; and

at least one common processing unit, which is connected to said sensing means and is mounted on said supporting structure, said unit comprising memory elements that contain reference data and comparison means for comparing said reference data with said physiological data acquired by said sensing means and for reporting them according to the outcome of the comparison.

### BRIEF DESCRIPTION OF THE DRAWINGS

Further characteristics and advantages of the invention will become better apparent from the description of a preferred but not exclusive embodiment of the portable device with sensors, illustrated only by way of non-limitative example in the accompanying drawings.

In particular, FIG. 1 is a perspective view of an embodiment of the device with sensors.

FIG. 2 is a block diagram of the device with sensors.

FIG. 3 is a block diagram of a receiver that is external to the device.

### DESCRIPTION OF THE PREFERRED EMBODIMENTS

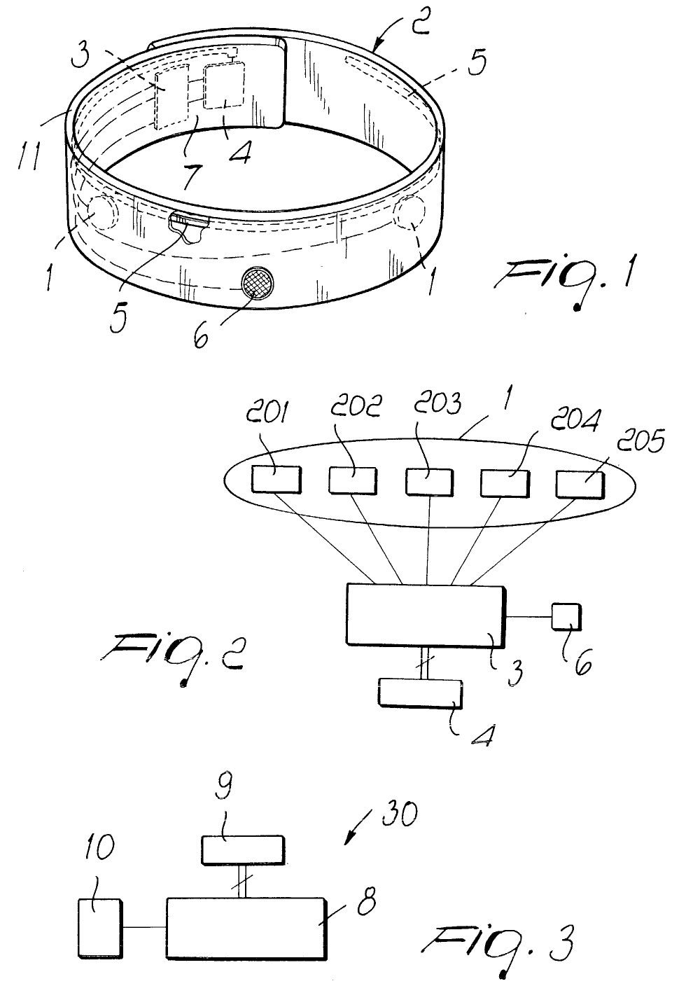

With reference to FIGS. 1 to 3, the device is constituted by a supporting structure 2 that is substantially annular and has dimensions that are substantially the same as those of an ordinary armband/bracelet or collar.

Sensing means 1 are mounted on the internal surface 7 of said supporting structure and are connected electrically to a common processing unit, which is mainly constituted by a microcontroller 3 that is accommodated inside the supporting structure 2.

Electromagnetic transmission means are placed on the supporting structure 2 and comprise an integrated transceiver 4 and an antenna 5, for example a strip antenna, that lies proximate to an edge 11 of the supporting structure 2.

In a remote location with respect to the device there is an intervention unit 30, which is coupled electromagnetically to the signal sent by the antenna 5 by means of a second transceiver 9 and is preferably connected to a second processing unit 8 and to actuation means 10. In FIG. 3, the actuation means 10 are shown schematically to be connected directly to the second processing unit 8, but they can also be coupled electromagnetically to the second processing unit 8 by virtue of the second transceiver 9 if, for example, they are in direct contact with the user, as described in greater detail hereinafter.

The microcontroller 3 is optionally connected to an acoustic emitter 6, which is preferably accommodated on the outer surface of the supporting structure.

Furthermore, the microcontroller 3, the sensing means 1 and the electromagnetic transmission means are powered by a battery, not shown in the figures, whose characteristics are described hereinafter.

The operation of the device in the particular embodiment that is described is as follows: suppose, for example, that the supporting structure is constituted by an armband and is worn by a patient.

The sensing means 1 are constituted by at least one sensor or by a plurality of sensors of various kinds, which by staying in contact with the patient's skin measure certain physiological values; currently, there are sensors for measuring heart rate 201, arterial pressure 202, body temperature 203, adrenaline content 204, electrical skin conduction 205, or other values.

The information that arrives from these sensors is read periodically by the microcontroller 3, which in addition to collecting the data according to methods known to the person skilled in the art, compares them by virtue of comparison means with values stored in memory means contained inside it.

On the basis of the comparison, the microcontroller evaluates the need to report said values, by activating an alarm, if one or more of them or a particular combination thereof dangerously exceed the clinically acceptable values.

The reference values are stored in the microcontroller 3 in at least one non-volatile memory, and the microcontroller can be of the programmable type, so as to update these values according to the parameters that are most suited to the patient.

The values can be read at the same frequency or at different frequencies, depending on the promptness of danger reporting that one wishes to obtain; for example, for reading data such as arterial pressure or heart rate, a reading every five seconds is sufficient.

In case of alarm, the microcontroller 3 reports the acquired data to the integrated transceiver 4, which in turn encodes them and sends them via the antenna 5 to the intervention unit 30; the encoding system is such as to univocally identify the patient, so that the intervention unit 30 can decode the data, associating it with a unique patient and thus allowing more prompt intervention. The network protocols for identifying an individual and/or the position of the individual are widely implemented in the known art.

The carrier frequency at which the antenna transmits is chosen at 2.4 GHz, thus allowing a half-wave length of the antenna 5 of approximately 6.25 cm, which is compatible with the dimensions of an armband.

The actuation means 10, which are part of the intervention unit 30, are preferably controlled by the second processing unit 8 and can comprise for example simply an electronic device connected to the telephone network, which dials a certain telephone number and reports to appropriate individuals, with a prerecorded voice message, the extent or kind of physiological imbalance that has occurred in a specific patient.

If the patient is instead in hospital or bedridden, the actuation means 10 can comprise for example a controller of a pump that injects into the bloodstream an appropriate dose of a particular substance, and so forth.

Furthermore, the actuation means can comprise the patient himself, in the particular case in which he can intervene autonomously; for example, if the user of the portable device with sensors is an ordinary car driver, appropriate sensors can detect, for example on the basis of the heart rate, when the driver falls asleep; in this case it is sufficient for the microcontroller 3 to activate solely the acoustic emitter 6 and the driver will wake up autonomously. In this case, nothing is transmitted by the antenna, and the actuation means 10 consist solely of the acoustic emitter 6 and are therefore independent of the second processing unit 8.

If instead the same driver has an accident, two consecutive acquisitions on the part of the microcontroller 3 by means of sensors such as pressure and/or heart rate sensors or others yield very different values, and depending on this difference the radio signal is also sent out.

Other possible actuation means 10 can be switches capable of interrupting the generation of electric current in case of a sudden increase in the value of electrical skin conduction, for example if a worker or simply a child accidentally makes contact with the electric current of a system. In this case, the microcontroller's reading of the sensors of interest must be performed at a much higher rate than the reading of heart rate or arterial pressure sensors, for example every 10 milliseconds.

The armband is preferably powered by means of lithium batteries, such as for example models BR2330 and CR2430 by Energizer, at 3 volts and 250 mAh. In the case of a device with many sensors and high power consumption, it is possible to use the U6VF-K2 battery by Ultralife, at 6.4 V and 600 mAh.

The second processing unit 8, preferably contained in the intervention unit 30 if it is in a remote location with respect to the armband, comprises a personal computer for managing one or more patients, for example patients under observation in a given hospital ward.

The invention thus conceived is susceptible of numerous modifications and variations, all of which are within the scope of the inventive concept; some of these variations have already been described and others can be proposed according to requirements.

In practice, the materials used, as well as the contingent shapes and dimensions, may be any according to requirements.

What is claimed is:

1. A portable device with sensors for signalling physiological data, comprising:
a supporting structure that can be worn by a human or animal user;
sensing means mounted on said supporting structure in order to acquire physiological data of said user; and
at least one common processing unit, which is connected to said sensing means and is mounted on said supporting structure, said unit comprising memory elements that contain reference data and comparison means for comparing said reference data with said physiological data acquired by said sensing means and for signalling them according to the outcome of the comparison.

2. The device according to claim 1, wherein said sensing means comprise physiological sensors.

3. The device according to claim 2, wherein said physiological sensors comprise at least one sensor chosen among the group constituted by a heart rate sensor, an arterial pressure sensor, an electric skin conduction sensor, a temperature sensor, a respiration rate sensor, an adrenaline sensor.

4. The device according to claim 1, wherein said supporting structure is an armband or a collar.

5. The device according to claim 1, further comprising electromagnetic transmission means, which are mounted on said supporting surface and are connected electronically to said common processing unit in order to transmit in electromagnetic form said physiological data acquired by said sensing means on the basis of the comparison and signalling performed by said comparison means.

6. The device according to claim 5, wherein said electromagnetic transmission means comprise at least one antenna, which is mounted on said supporting structure in order to couple electromagnetically said electromagnetic transmission means to at least one intervention unit located remotely with respect to said device, and a first transceiver, which is mounted on said supporting structure.

7. The device according to claim 6, wherein said antenna is of the half-wave type and wherein the transmission carrier frequency is substantially 2.4 GHz.

8. The device according to claim 6, wherein said at least one intervention unit comprises a second transceiver in order to couple electromagnetically to said first transceiver and said antenna.

9. The device according to claim 1, further comprising at least one intervention unit that can be activated on the basis of the comparison and signalling performed by said comparison means.

10. The device according to claim 9, wherein said intervention unit is located remotely with respect to said device.

11. The device according to claim 9, wherein said at least one intervention unit comprises actuation means for performing an intervention that depends on the comparison and reporting performed by said comparison means.

12. The device according to claim 11, wherein said intervention unit comprises a second processing unit for managing and controlling said actuation means.

13. The device according to claim 12, wherein said second processing unit processes information that arrives from a plurality of users.

14. The device according to claim 9, wherein said intervention unit is mounted on said device.

15. The device according to claim 14, wherein said at least one intervention unit comprises actuation means for performing an intervention that depends on the comparison and reporting performed by said comparison means.

16. The device according to claim 15, wherein said actuation means comprise at least one acoustic emitter that is mounted on said supporting structure and is connected electrically to said processing unit.

17. The device according to claim 1, wherein said at least one common processing unit comprises a microcontroller or microprocessor.
